(19) United States
(12) Patent Application Publication
(10) Pub. No.: US 2022/0320716 A1
(43) Pub. Date: Oct. 6, 2022

(54) RADIATING ELEMENT AND MULTI-BAND BASE STATION ANTENNA

(71) Applicant: CommScope Technologies LLC, Hickory, NC (US)

(72) Inventors: Jian Zhang, Suzhou (CN); Bo Wu, Richardson, TX (US)

(21) Appl. No.: 17/695,974

(22) Filed: Mar. 16, 2022

(30) Foreign Application Priority Data
Apr. 2, 2021 (CN) 2021103604215

(51) Int. Cl. H01Q 1/24; H01Q 1/38; H01Q 19/10; H01Q 9/28; H01Q 9/04

(52) U.S. Cl. CPC H01Q 1/246; H01Q 1/38; H01Q 19/108; H01Q 9/285; H01Q 9/045; H01Q 21/28

(57) ABSTRACT

A radiating element includes a feed rod and a radiator mounted on the feed rod. The radiator includes a dielectric substrate, a first dipole arranged along a first axis and including a first dipole arm and a second dipole arm, and a second dipole arranged along a second axis perpendicular to the first axis and including a third dipole arm and a fourth dipole arm. Each dipole arm includes a closed conductive segment provided on the dielectric substrate and conductive patches are respectively provided on the dielectric substrate within boundaries defined by the closed conductive segment of each dipole arm. The dielectric substrate with the closed conductive segments and conductive patches constitutes a frequency selective surface which is configured to allow radiation in a frequency range higher than the operating frequency range of the radiating element to pass.

### CROSS-REFERENCE TO RELATED APPLICATION

The present application claims priority to Chinese Patent Application No. 202110360421.5, filed Apr. 2, 2021, the entire content of which is incorporated herein by reference as if set forth fully herein.

### FIELD

The present disclosure generally relates to the field of antennas, and more specifically the present disclosure relates to radiating elements for use in multi-band base station antennas and multi-band base station antennas including such radiating elements

### BACKGROUND

With the development of wireless communication technology, the requirements on integration and miniaturization of antennas become higher and higher, and it is usually necessary to arrange a large number of radiating elements operating in a variety of different frequency bands within a space as small as possible. This may cause radiating elements operating in different frequency bands to affect radiation performance of one another, making it challenging for multi-band antennas to maintain high performance while improving integration and miniaturization. For example, in some multi-band antenna applications, a low frequency band may be the 617 MHz to 960 MHz frequency range or a portion thereof, a middle frequency band may be the 1.7 GHz to 2.7 GHz frequency range or a portion thereof, and a high frequency band may be the 3.3 GHz to 4.2 GHz frequency range or a portion thereof. The size of a radiating element is inversely proportional to its operating frequency band. Thus, the low-band radiating elements are typically larger than the mid-band radiating elements, and the mid-band radiating elements are typically larger than the high-band radiating elements. Since cellular operators may have strict limits on the size of a base station antenna, in many multi-band base station antennas it is necessary to position higher band radiating elements behind lower band radiating elements. The lower band radiating elements may block the higher band radiating elements or otherwise impact the radiation pattern thereof, potentially resulting in significant deterioration of the radiation pattern of the higher band radiating elements.

### SUMMARY

According to a first aspect of the present disclosure, a radiating element is provided, including: a feed rod; and a radiator mounted on the feed rod, the radiator includes: a dielectric substrate; a first dipole arranged along a first axis and including a first dipole arm and a second dipole arm; and a second dipole arranged along a second axis perpendicular to the first axis and including a third dipole arm and a fourth dipole arm, wherein each of the first dipole arm to the fourth dipole arm includes a closed conductive segment provided on the dielectric substrate; wherein, conductive patches are respectively provided on the dielectric substrate within boundaries defined by the closed conductive segment of each of the first dipole arm to the fourth dipole arm, and wherein, the dielectric substrate with the closed conductive segments and conductive patches constitutes a frequency selective surface, which is configured to allow radiation in a frequency range higher than the operating frequency range of the radiating element to pass.

In some embodiments, the closed conductive segment of each of the first dipole arm and the second dipole arm is symmetrical about the first axis, and/or the closed conductive segment of each of the third dipole arm and the fourth dipole arm is symmetrical about the second axis.

In some embodiments, the conductive patch in each of the first dipole arm and the second dipole arm is symmetrical about the first axis, and/or the conductive patch in each of the third dipole arm and the fourth dipole arm is symmetrical about the second axis.

In some embodiments, each closed conductive segment on the dielectric substrate is rotationally symmetrical about an intersection of the first axis and the second axis, and/or each conductive patch on the dielectric substrate is rotationally symmetrical about the intersection of the first axis and the second axis.

In some embodiments, the closed conductive segment of each of the first dipole arm to the fourth dipole arm is in a square annular shape, and/or the conductive patch of each of the first dipole arm to the fourth dipole arm is a polygon, a polygonal ring, or a combination of a polygon and a polygonal ring.

In some embodiments, each of the first dipole arm and the second dipole arm has a length on the first axis equal to a quarter of the center wavelength of the operating frequency range of the radiating element, and/or each of the third dipole arm and the fourth dipole arm has a length on the second axis equal to a quarter of the center wavelength of the operating frequency range of the radiating element.

In some embodiments, the closed conductive segment and the conductive patch are arranged on the same surface of the dielectric substrate.

In some embodiments, the closed conductive segment and the conductive patch are arranged on different surfaces of the dielectric substrate.

In some embodiments, at least a portion of a closed conductive segment of at least one of the first dipole arm to the fourth dipole arm is disposed on a different surface of the dielectric substrate than remaining portions of the closed conductive segment, and/or at least a portion of a conductive patch within at least one of the first dipole arm to the fourth dipole arm is disposed on a different surface of the dielectric substrate than remaining portions of the conductive patch.

In some embodiments, at least a portion of a closed conductive segment of at least one of the first dipole arm to the fourth dipole arm is disposed on a different surface of the dielectric substrate than at least a portion of a conductive patch within at least one of the first dipole arm to the fourth dipole arm.

In some embodiments, the dielectric substrate is a multilayer dielectric substrate, and the closed conductive segment and the conductive patch are arranged on the same layer or different layers of the multilayer dielectric substrate.

In some embodiments, the dielectric substrate is a multilayer dielectric substrate, wherein at least a portion of a closed conductive segment of at least one of the first dipole arm to the fourth dipole arm is disposed on a different layer of the multilayer dielectric substrate than remaining portions of the closed conductive segment, and/or wherein at least a portion of a conductive patch within at least one of the first dipole arm to the fourth dipole arm is disposed on a different layer of the multilayer dielectric substrate than remaining portions of the conductive patch.

In some embodiments, the dielectric substrate is a multilayer dielectric substrate, and wherein at least a portion of a closed conductive segment of at least one of the first dipole arm to the fourth dipole arm is disposed on a different layer of the multilayer dielectric substrate than at least a portion of a conductive patch within at least one of the first dipole arm to the fourth dipole arm.

In some embodiments, the closed conductive segment and the conductive patch are made of metal.

According to a second aspect of the present disclosure, a multi-band base station antenna is provided, including: a reflector; a first radiating element mounted on the reflector, the first radiating element being configured to operate in a first operating frequency range; and a second radiating element mounted on the reflector, the second radiating element being configured to operate in a second operating frequency range which is higher than the first operating frequency range, wherein, the first radiating element is the radiating element according to any embodiment of the first aspect of the present disclosure, and the frequency selective surface of the first radiating element is configured to allow radiation in the second operating frequency range to pass.

In some embodiments, a radiator of the first radiating element is farther from the reflector than the radiator of the second radiating element, and when viewed from a direction perpendicular to the surface of the reflector, the radiator of the first radiating element covers at least a part of the radiator of the second radiating element.

In some embodiments, the multi-band base station antenna includes a plurality of first radiating elements and a plurality of second radiating elements, and the plurality of first radiating elements and the plurality of second radiating elements are arranged such that, when viewed from a direction perpendicular to the surface of the reflector, each first radiating element at least partially overlaps with one or more second radiating elements.

In some embodiments, when viewed from a direction perpendicular to the surface of the reflector, each of the one or more second radiating elements with which each first radiating element at least partially overlaps is located below a corresponding dipole arm of that first radiating element.

In some embodiments, the second radiating element is a patch dipole radiating element.

In some embodiments, the multi-band base station antenna further includes a third radiating element mounted on the reflector, and the third radiating element is configured to operate in a third operating frequency range which is lower than the first operating frequency range.

In some embodiments, the third radiating element is configured to be cloaked to radiation in the first operating frequency range and the second operating frequency range.

In some embodiments, the third radiating element is the radiating element according to any embodiment of the first aspect of the present disclosure, and the frequency selective surface of the third radiating element is configured to allow radiation in the first operating frequency range and the second operating frequency range to pass.

In some embodiments, the third radiating element includes a cross dipole radiator, each dipole arm of the cross dipole radiator includes a corresponding conductive segment and a corresponding inductor capacitor circuit, and the inductor capacitor circuit defines a filter, which is configured to allow radiation in the first operating frequency range and the second operating frequency range to pass.

In some embodiments, the third radiating element includes a cross dipole radiator, each dipole arm of the cross dipole radiator includes a plurality of dipole segments and chokes arranged between adjacent dipole segments of the plurality of dipole segments, and the chokes are configured to minimize the effect of current induced in the dipole arm of the third radiating element by radiation in the first operating frequency range and the second operating frequency range.

In some embodiments, a radiator of the third radiating element is farther from the reflector than the radiator of the first radiating element, the radiator of the first radiating element is farther from the reflector than the radiator of the second radiating element, and when viewed from a direction perpendicular to the surface of the reflector, the radiator of the third radiating element covers at least a part of the radiator of the first radiating element, and the radiator of the first radiating element covers at least a part of the radiator of the second radiating element.

In some embodiments, the multi-band base station antenna includes a plurality of first radiating elements, a plurality of second radiating elements, and a plurality of third radiating elements; and the plurality of first radiating elements, the plurality of second radiating elements, and the plurality of third radiating elements are arranged such that, when viewed from a direction perpendicular to the surface of the reflector, each third radiating element at least partially overlaps with one or more first radiating elements, and each first radiating element at least partially overlaps with one or more second radiating elements.

In some embodiments, when viewed from a direction perpendicular to the surface of the reflector, each of the one or more first radiating elements with which each third radiating element at least partially overlaps is located below a corresponding dipole arm of that third radiating element, and each of the one or more second radiating elements with which each first radiating element at least partially overlaps is located below a corresponding dipole arm of that first radiating element.

In some embodiments, the first operating frequency range is at least a portion of the 1.7 GHz to 2.7 GHz frequency range, the second operating frequency range is at least a portion of the 3.3 GHz to 4.2 GHz frequency range, and the third operating frequency range is at least a portion of the 617 MHz to 960 MHz frequency range.

According to a third aspect of the present disclosure, a radiating element is provided, including: a feed stalk; and a radiator mounted on the feed stalk, the radiator including a plurality of dipole arms, wherein the dipole arms are part of a frequency selective surface that is configured to pass radiation in a pre-selected frequency band.

In some embodiments, the frequency selective surface comprises a parallel inductor-capacitor resonance circuit.

In some embodiments, the radiator further includes a plurality of conductive patches.

In some embodiments, each dipole arm defines an open interior, and wherein each conductive patch is positioned within an open interior of a respective one of the dipole arms.

In some embodiments, the dipole arms and the conductive patches are formed on a dielectric substrate.

In some embodiments, at least a portion of the conductive patch is on a different surface of the dielectric substrate than at least a portion of one of the dipole arms.

According to a fourth aspect of the present disclosure, a multi-band base station antenna is providing, including: a reflector; a first radiating element mounted on the reflector, the first radiating element being configured to operate in a first operating frequency range; and a second radiating element mounted on the reflector, the second radiating element being configured to operate in a second operating frequency range which is higher than the first operating frequency range, wherein, the first radiating element is the radiating element according to any embodiment of the third aspect of the present disclosure, and the frequency selective surface of the first radiating element is configured to allow radiation in the second operating frequency range to pass.

In some embodiments, a radiator of the first radiating element is farther from the reflector than the radiator of the second radiating element, and when viewed from a direction perpendicular to the surface of the reflector, the radiator of the first radiating element covers at least a part of the radiator of the second radiating element.

Through the following detailed description of exemplary embodiments of the present disclosure by referencing the attached drawings, other features and advantages of the present disclosure will become clearer.

### BRIEF DESCRIPTION OF THE DRAWING

FIG. 1A is a top cross-sectional view of a radiating element according to some embodiments of the present disclosure.

FIG. 1B is a front view of the radiating element of FIG. 1A.

FIG. 2A to FIG. 2E respectively show exemplary patterns of a frequency selective surface of a radiating element according to some embodiments of the present disclosure.

FIG. 2F and FIG. 2G shows example arrangements of a dipole arm of a radiating element according to some embodiments of the present disclosure.

FIG. 3A is a perspective view of a multi-band base station antenna according to some embodiments of the present disclosure.

FIG. 3B is a top cross-sectional view of the multi-band base station antenna in FIG. 3A.

FIG. 4A and FIG. 4B respectively show exemplary layouts of a plurality of radiating elements of different frequency bands in the multi-band base station antenna in FIG. 3A.

FIG. 5A and FIG. 5B respectively show radiation patterns of a lower band radiating element and a higher band radiating element in the multi-band base station antenna in FIG. 3A.

FIG. 6 is a perspective view of a conventional multi-band base station antenna.

FIG. 7A and FIG. 7B respectively show radiation patterns of a lower band radiating element and a higher band radiating element in the conventional multi-band base station antenna in FIG. 6.

FIG. 8A is a perspective view of a multi-band base station antenna according to some embodiments of the present disclosure.

FIG. 8B is a top cross-sectional view of the multi-band base station antenna in FIG. 8A.

FIG. 8C is a front view of a low-band radiating element included in the multi-band base station antenna in FIG. 8A.

FIG. 9A to FIG. 9C respectively show exemplary layouts of a plurality of radiating elements of different frequency bands in the multi-band base station antenna in FIG. 8A.

FIG. 10A is a front view of a multi-band base station antenna according to some embodiments of the present disclosure.

FIG. 10B is a front view of a low-band radiating element included in the multi-band base station antenna in FIG. 10A; and

FIG. 11 is a front view of a multi-band base station antenna according to some embodiments of the present disclosure.

Note, in the embodiments described below, the same signs are sometimes used in common between different attached drawings to denote the same parts or parts with the same functions, and repeated descriptions thereof are omitted. In some cases, similar labels and letters are used to indicate similar items. Therefore, once an item is defined in one attached drawing, it does not need to be further discussed in subsequent attached drawings.

For ease of understanding, the position, dimension, and range of each structure shown in the attached drawings and the like may not indicate the actual position, dimension, and range. Therefore, the present disclosure is not limited to the positions, dimensions, and ranges disclosed in the attached drawings and the like.

### DETAILED DESCRIPTION

Various exemplary embodiments of the present disclosure will be described in detail below by referencing the attached drawings. It should be noted: unless otherwise specifically stated, the relative arrangement, numerical expressions and numerical values of components and steps set forth in these embodiments do not limit the scope of the present disclosure.

The following description of at least one exemplary embodiment is actually only illustrative, and in no way serves as any limitation to the present disclosure and its application or use. In other words, the structure and method herein are shown in an exemplary manner to illustrate different embodiments of the structure and method in the present disclosure. However, those skilled in the art will understand that they only illustrate exemplary ways of implementing the present disclosure, rather than exhaustive ways. In addition, the attached drawings are not necessarily drawn to scale, and some features may be enlarged to show details of specific components.

In addition, the technologies, methods, and equipment known to those of ordinary skill in the art may not be discussed in detail, but where appropriate, the technologies, methods, and equipment should be regarded as part of the granted Specification.

In all examples shown and discussed herein, any specific value should be construed as merely exemplary value and not as limiting value. Therefore, other examples of the exemplary embodiment may have different values.

In a multi-band antenna, radiating elements of different frequency bands may interfere with each other, particularly if the radiating elements are positioned in close proximity to each other. With the development of wireless communication technology, the global communication method has gradually developed from the early 2G to the current 5G, from the early single port to the current dozens f ports, and the requirements on integration of antennas become higher and higher. At the same time, it is also expected to maintain the miniaturization of the antenna while increasing the degree of integration of the antenna. These requirements result in an extremely complex electromagnetic field environment in the limited space inside the antenna. In particular, there is mutual interference between signals of different frequency bands, resulting in a distortion of the radiation pattern of the radiating elements operating in each frequency band, which serious affects the overall performance of the antenna.

A frequency selective surface can filter electromagnetic radiation in space. By periodically arranging a plurality of frequency selective surface units on a two-dimensional plane, a metamaterial with a specific reflection/transmission phase distribution can be formed. When electromagnetic radiation is incident on the frequency selective surface, the frequency selective surface can selectively pass/block radiation of different frequencies.

The present disclosure provides a radiating element based on a frequency selective surface, and the radiating element is capable of being “cloaked” to radiation in a frequency range different from the operating frequency range of the radiating element (“being cloaked” means that the radiating element has little or no effect on radiation in a frequency range different from the operating frequency range of the radiating element). Therefore, when such a radiating element and a radiating element operating in another frequency band are together in a narrow internal space of the antenna, the radiating element will not affect or has little effect on the performance of the radiating element operating in the other frequency band.

A radiating element according to an embodiment of the present disclosure may comprise a feed stalk and a radiator mounted on the feed stalk. The radiator may include a plurality of dipole arms, wherein the dipole arms are part of a frequency selective surface that is configured to pass radiation in a pre-selected frequency band. For example, the pre-selected frequency band may be a frequency band higher than an operating frequency band of the radiating element. Further, the radiator may further include a plurality of conductive patches. These conductive patches may also be part of the frequency selective surface. Further, each dipole arm of the radiator may define an open interior, and each conductive patch may be positioned within an open interior of a respective one of the dipole arms. That is, each conductive patch may be positioned in a region surrounded by a respective one of the dipole arms. For example, the dipole arms and the conductive patches may be formed on a dielectric substrate, and optionally, at least a portion of the conductive patch may be on a different surface of the dielectric substrate than at least a portion of one of the dipole arms.

Next, radiating elements according to embodiments of the present disclosure will be described in detail with reference to the accompanying drawings.

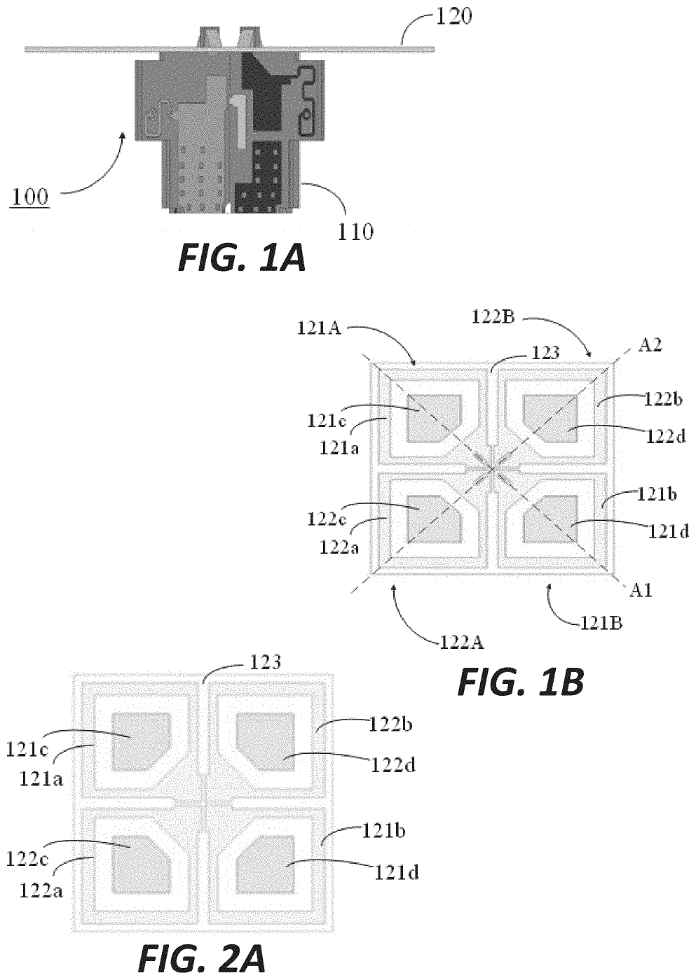

FIG. 1A and FIG. 1B show a radiating element 100 according to some embodiments of the present disclosure. As shown in FIG. 1A, the radiating element 100 may include a feed stalk 110 and a radiator 120 mounted on the feed stalk 110. In the depicted embodiment, the feed stalk comprises a pair of printed circuit boards that are mated to define an X-shaped structure. It will be appreciated, however, that other feed stalks may be used such as sheet metal feed stalks, die cast feed stalks and the like.

As shown in FIG. 1B, the radiator 120 may include a dielectric substrate 123, a first dipole arranged along a first axis Al and including a first dipole arm 121A and a second dipole arm 121B, and a second dipole arranged along a second axis A2 substantially perpendicular to the first axis Al and including a third dipole arm 122A and a fourth dipole arm 122B. The radiator 120 may be a cross dipole radiator. As used herein, “substantially perpendicular” means that the angle between the two is from 70° to 110°, preferably from 80° to 100°, more preferably from 85° to 95°, and is most preferably 90°.

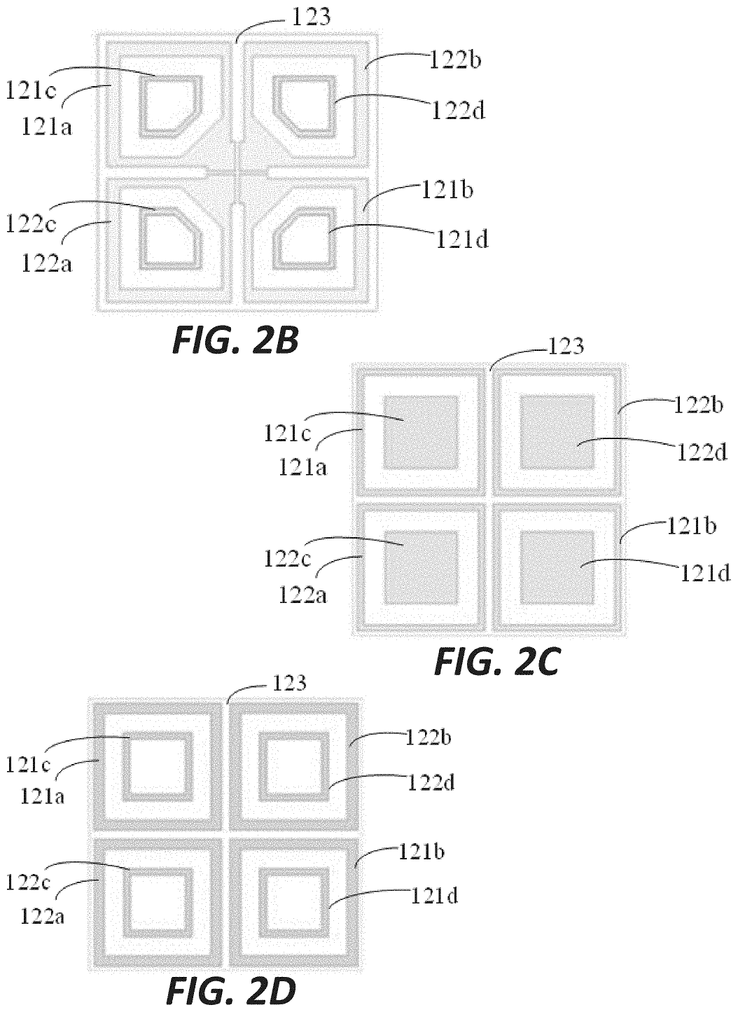

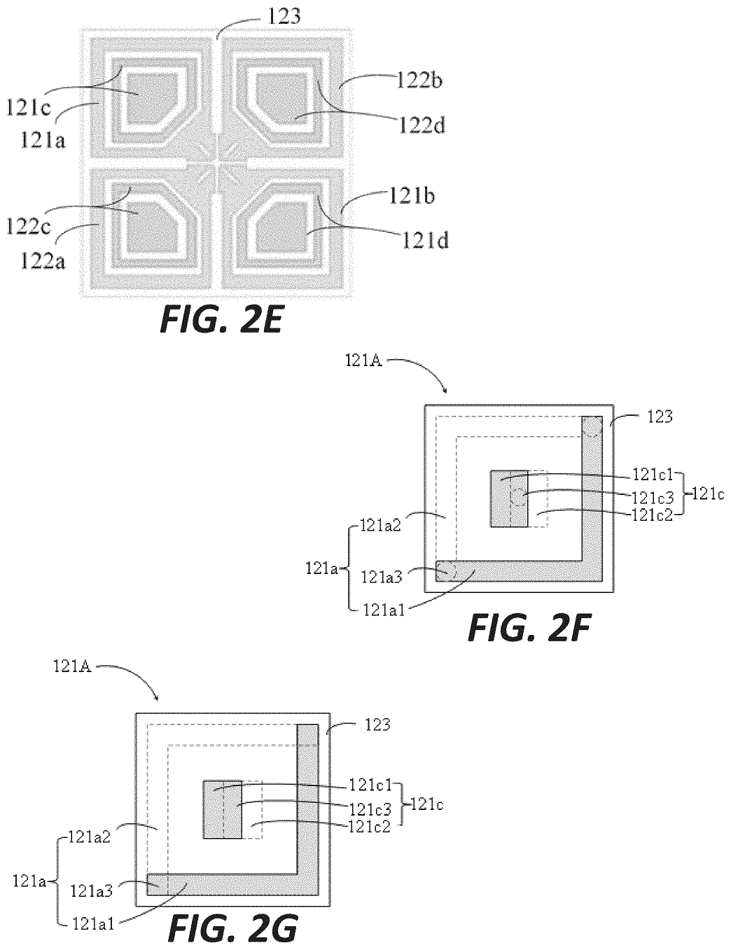

In FIG. 1B and the subsequent FIGS. 2A to 2G, the white portion is a portion of the dielectric substrate 123, and the gray portion is formed of a conductive material. As shown in the drawings, each of the first dipole arm to the fourth dipole arm, 121A, 121B, 122A, and 122B, may include a closed conductive segment, i.e., 121a, 121b, 122a, 122b, provided on the dielectric substrate 123. In addition, conductive patches 121c, 121d, 122c, and 122d are respectively provided on the dielectric substrate 123 within boundaries defined by the respective closed conductive segments 121a, 121b, 122a, 122b of each of the first dipole arm to the fourth dipole arm 121A, 121B, 122A, and 122B. The dielectric substrate 123 with the closed conductive segments 121a, 121b, 122a, and 122b and the conductive patches 121c, 121d, 122c, and 122d may constitute a frequency selective surface, which may be configured to allow radiation in a frequency range higher than the operating frequency range of the radiating element 100 to pass. As a result, in the radiating element 100, the closed conductive segments 121a, 121b, 122a, and 122b can be used as dipole arms of the radiator 120 and can also form a frequency selective surface together with the conductive patches 121c, 121d, 122c, and 122d, so that the radiating element 100 can be cloaked to radiation in a frequency range higher than the operating frequency range of the radiating element 100.

It should be noted that the term “closed conductive segment” as used herein shall not be construed as being limited to a physically enclosed conductive segment, but more generally refer to a conductive segment forming an electrically enclosed loop. This will be further explained later with specific embodiments. As an example, a closed conductive segment may comprise a plurality of conductive portions collectively defining a substantially ring shape. When the plurality of conductive portions are directly electrically connected to each other, such a closed conductive segment not only forms an electrically enclosed loop but also is physically enclosed. As another example, a closed conductive segment may comprise a plurality of conductive portions collectively defining a substantially ring shape. When the plurality of conductive portions are capacitively coupled to each other, such a closed conductive segment forms an electrically enclosed loop, but it could be considered to be at least partially open from a physical perspective. As yet another example, a conductive segment of a dipole arm may comprise a first conductive portion and a second conductive portion that are directly electrically connected to each other at proximal ends (in proximity to the feed stalk side) thereof and are separated from each other by a small gap at distal ends thereof. Further, the first and second conductive portions may each have an extension at the distal end thereof. The extension of the first conductive portion and the extension of the second conductive portion are substantially parallel to each other to maintain the small gap. Such extensions may be used to improve the coupling between the first and second conductive portions.

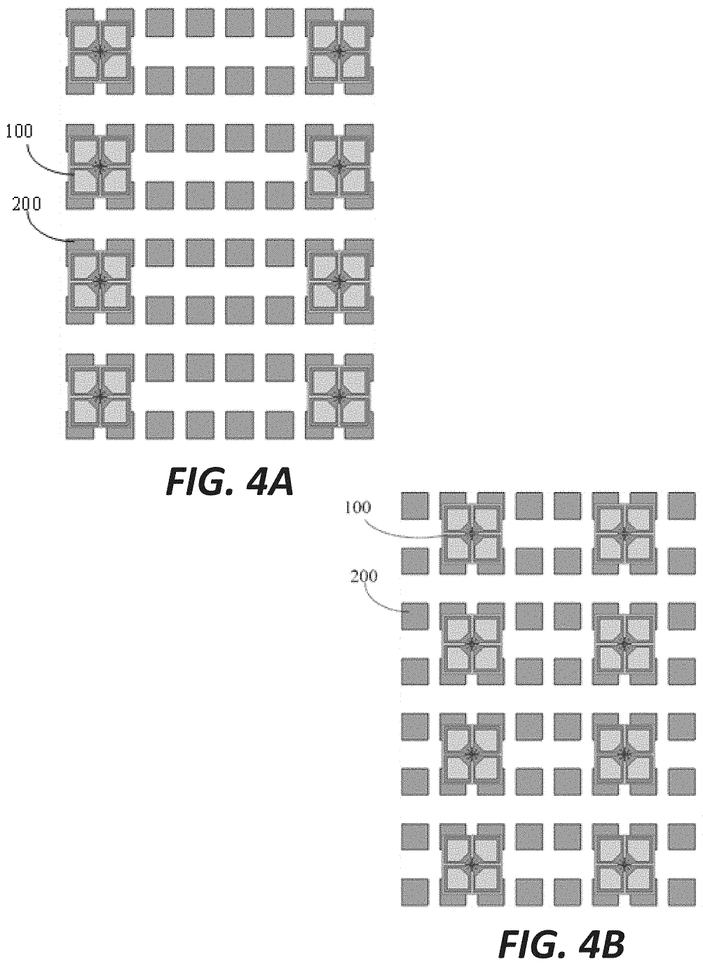

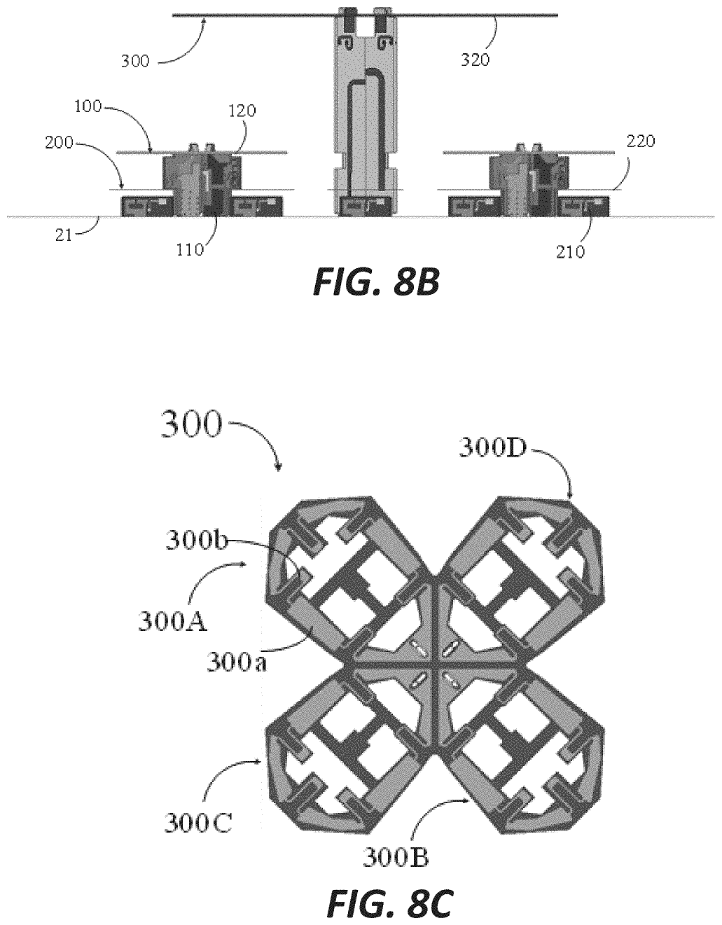

In the drawings, the closed conductive segments and the conductive patches are displayed at the same time in order to better show the shapes of the closed conductive segments and the conductive patches. However, this does not mean that the closed conductive segments and the conductive patches must be provided on the same surface of the dielectric substrate 123 at the same time. In some embodiments, the closed conductive segments 121a, 121b, 122a, and 122b and the conductive patches 121c, 121d, 122c, and 122d may be provided on the same surface of the dielectric substrate 123. In other embodiments, the closed conductive segments 121a, 121b, 122a, and 122b and the conductive patches 121c, 121d, 122c, and 122d may be provided on different surfaces of the dielectric substrate 123 (for example, as shown in FIG. 4A, FIG. 4B, FIG. 8A, etc.). In some embodiments, at least one of the closed conductive segments 121a, 121b, 122a, and 122b may be provided on a different surface of the dielectric substrate 123 than others of the closed conductive segments 121a, 121b, 122a, and 122b. In some embodiments, at least one of the conductive patches 121c, 121d, 122c, and 122d may be provided on a different surface of the dielectric substrate 123 than others of the conductive patches 121c, 121d, 122c, and 122d. In still other embodiments, the dielectric substrate 123 may be a multilayer dielectric substrate, and the closed conductive segments 121a, 121b, 122a, and 122b and the conductive patches 121c, 121d, 122c, and 122d are provided on the same layer or different layers of the multilayer dielectric substrate. In some embodiments, at least one of the closed conductive segments 121a, 121b, 122a, and 122b may be provided on a different layer of the multilayer dielectric substrate than others of the closed conductive segments 121a, 121b, 122a, and 122b. In some embodiments, at least one of the conductive patches 121c, 121d, 122c, and 122d may be provided on a different layer of the multilayer dielectric substrate than others of the conductive patches 121c, 121d, 122c, and 122d.

In some embodiments, at least a portion of a closed conductive segment of at least one of the first dipole arm to the fourth dipole arm may be disposed on a different surface of the dielectric substrate 123 or on a different layer of the dielectric substrate 123 that is a multilayer dielectric substrate from remaining portions of the closed conductive segment. In some embodiments, at least a portion of each closed conductive segment of the first dipole arm 121A and the second dipole arm 121B of the first dipole may be disposed on a different surface of the dielectric substrate 123 or on a different layer of the dielectric substrate 123 that is a multilayer dielectric substrate from remaining portions of the closed conductive segment. Preferably, the distribution of portions of the closed conductive segment of the first dipole arm 121A on different surfaces of the dielectric substrate 123 or on different layers of the dielectric substrate 123 that is a multilayer dielectric substrate and the distribution of portions of the closed conductive segment of the second dipole arm 121B on different surfaces of the dielectric substrate 123 or on different layers of the dielectric substrate 123 that is a multilayer dielectric substrate are symmetrical or substantially symmetrical about the second axis A2. In some embodiments, at least a portion of each closed conductive segment of the third dipole arm 122A and the fourth dipole arm 122B of the second dipole may be disposed on a different surface of the dielectric substrate 123 or on a different layer of the dielectric substrate 123 that is a multilayer dielectric substrate from remaining portions of the closed conductive segment. Preferably, the distribution of portions of the closed conductive segment of the third dipole arm 122A on different surfaces of the dielectric substrate 123 or on different layers of the dielectric substrate 123 that is a multilayer dielectric substrate and the distribution of portions of the closed conductive segment of the fourth dipole arm 122B on different surfaces of the dielectric substrate 123 or on different layers of the dielectric substrate 123 that is a multilayer dielectric substrate are symmetrical or substantially symmetrical about the first axis Al.

In some embodiments, at least a portion of a conductive patch within at least one of the first dipole arm to the fourth dipole arm may be disposed on a different surface of the dielectric substrate 123 or on a different layer of the dielectric substrate 123 that is a multilayer dielectric substrate from remaining portions of the conductive patch. In some embodiments, at least a portion of each conductive patch within the first dipole arm 121A and the second dipole arm 121B of the first dipole may be disposed on a different surface of the dielectric substrate 123 or on a different layer of the dielectric substrate 123 that is a multilayer dielectric substrate from remaining portions of the conductive patch. Preferably, the distribution of portions of the conductive patch within the first dipole arm 121A on different surfaces of the dielectric substrate 123 or on different layers of the dielectric substrate 123 that is a multilayer dielectric substrate and the distribution of portions of the conductive patch within the second dipole arm 121B on different surfaces of the dielectric substrate 123 or on different layers of the dielectric substrate 123 that is a multilayer dielectric substrate are symmetrical or substantially symmetrical about the second axis A2. In some embodiments, at least a portion of each conductive patch within the third dipole arm 122A and the fourth dipole arm 122B of the second dipole may be disposed on a different surface of the dielectric substrate 123 or on a different layer of the dielectric substrate 123 that is a multilayer dielectric substrate from remaining portions of the conductive patch. Preferably, the distribution of portions of the conductive patch within the third dipole arm 122A on different surfaces of the dielectric substrate 123 or on different layers of the dielectric substrate 123 that is a multilayer dielectric substrate and the distribution of portions of the conductive patch within the fourth dipole arm 122B on different surfaces of the dielectric substrate 123 or on different layers of the dielectric substrate 123 that is a multilayer dielectric substrate are symmetrical or substantially symmetrical about the first axis Al.

In above cases, portions of the closed conductive segment or the conductive patch that are disposed on different surfaces of the dielectric substrate 123 or on different layers of the dielectric substrate 123 that is a multilayer dielectric substrate may be directly electrically connected with each other via conduction connection member(s) such as plated-through hole(s), or may be capacitively coupled to each other via coupling region(s) therebetween (i.e., overlapping region(s) between these portions), so as to be electrically continuous.

For example, FIG. 2F shows the first dipole arm 121A as an example, wherein the closed conductive segment 121a includes a first portion 121a1 disposed on a first surface (the illustrated surface) of the dielectric substrate 123, a second portion 121a2 disposed on a second surface opposite to the first surface of the dielectric substrate 123 (dash lines indicate that it is on a surface opposite to the illustrated surface), and a conductive connection member 121a3 for electrically connecting the first portion 121a1 and the second portion 121a2. Additionally, or optionally, in FIG. 2F, the conductive patch 121c includes a first portion 121c1 disposed on the first surface (the illustrated surface) of the dielectric substrate 123, a second portion 121c2 disposed on the second surface opposite to the first surface of the dielectric substrate 123 (dash lines indicate that it is on the surface opposite to the illustrated surface), and a conductive connection member 121c3 for electrically connecting the first portion 121c1 and the second portion 121c2. Although the conductive connection member 121a3, 121c3 is shown as a circular conductive through hole in FIG. 2F, it can be appreciated that this is merely exemplary but not limiting, any suitable number of conductive connection members 121a3, 121c3 having any suitable shape and/or size and employing any suitable form may be disposed at any suitable locations as desired.

For example, FIG. 2G also shows the first dipole arm 121A as an example, wherein the closed conductive segment 121a includes a first portion 121a1 disposed on a first surface (the illustrated surface) of the dielectric substrate 123, a second portion 121a2 disposed on a second surface opposite to the first surface of the dielectric substrate 123 (dash lines indicate that it is on a surface opposite to the illustrated surface), and an overlapping region 121a3 between the first portion 121a1 and the second portion 121a2 that is used as a coupling region for the first portion 121a1 and the second portion 121a2 such that the first portion 121a1 and the second portion 121a2 are capacitively coupled to each other. Additionally, or optionally, in FIG. 2G, the conductive patch 121c includes a first portion 121c1 disposed on the first surface (the illustrated surface) of the dielectric substrate 123, a second portion 121c2 disposed on the second surface opposite to the first surface of the dielectric substrate 123 (dash lines indicate that it is on the surface opposite to the illustrated surface), and an overlapping region 121c3 between the first portion 121c1 and the second portion 121c2 that is used as a coupling region for the first portion 121c1 and the second portion 121c2 such that the first portion 121c1 and the second portion 121c2 are capacitively coupled to each other. In the example as shown by FIG. 2G, although the closed conductive segment 121a is not physically enclosed, but it forms an electrically enclosed loop. Although the coupling region 121a3, 121c3 is shown as having a rectangular shape in FIG. 2G, it can be appreciated that this is merely exemplary but not limiting, any suitable number of coupling regions 121a3, 121c3 having any suitable shape and/or size may be disposed at any suitable locations as desired.

In FIG. 2F and FIG. 2G, the division of portions of the closed conductive segment and the conductive patch is merely exemplary but not limiting, the closed conductive segment and the conductive patch may be divided into any suitable number of portions having any suitable shape and/or size, respectively. Moreover, the closed conductive segment or the conductive patch may include not only portions located on different surfaces of the dielectric substrate and directly electrically connected with each other by conductive connection members, but also portions located on different surfaces of the dielectric substrate and capacitively coupled to each other via coupling regions.

In some embodiments, at least a portion of a closed conductive segment of at least one of the first dipole arm to the fourth dipole arm may be disposed on a different surface of the dielectric substrate 123 or on a different layer of the dielectric substrate 123 that is a multilayer dielectric substrate than at least a portion of a conductive patch within at least one of the first dipole arm to the fourth dipole arm.

The closed conductive segment and the conductive patch may be respectively formed of any suitable conductive material. For example, the closed conductive segment and the conductive patch may be made of metal.

The frequency selective surface of the radiating element 100 may include a conductive structure having multiple unit structures, and the conductive structure may be a combination of a first conductive structure formed by the closed conductive segments and a second conductive structures formed by the conductive patch, each unit structure may be constituted by a closed conductive segment and a conductive patch that the closed conductive segment surrounds. The closed conductive segment may be regarded as an inductor, and a gap between the conductive patch and the closed conductive segment may be regarded as a capacitor. Therefore, the unit structure including the closed conductive segment and the corresponding conductive patch can be equivalent to an inductor-capacitor (LC) resonance circuit (for example, it can be equivalent to a parallel LC resonance circuit). By designing the specific shape, size, spacing and the like of the closed conductive segment and the conductive patch, it is possible to realize an equivalent LC resonance circuit with desired equivalent inductance and equivalent capacitance, and to further set the frequency range allowed by the frequency selective surface to pass to a desired frequency range. In addition, the function of the closed conductive segment as a dipole arm also needs to be considered in the design of the closed conductive segment so as to realize a normal operation of the radiating element 100.

In some embodiments, each of the first dipole arm 121A and the second dipole arm 121B may have a length on the first axis Al equal to about a quarter of the center wavelength of the operating frequency range of the radiating element 100, and/or each of the third dipole arm 122A and the fourth dipole arm 122B may have a length on the second axis A2 equal to about a quarter of the center wavelength of the operating frequency range of the radiating element 100. The center wavelength refers to the wavelength corresponding to the center frequency of the operating frequency range. The term “about” herein may mean equal to the value described by the term or within ±20% of the value described by the term, preferably within ±10%, more preferably within ±5%, most preferably within ±1%, etc. Such a closed conductive segment can serve as a dipole arm of the radiator 120 well.

In some embodiments, the closed conductive segment of each of the first dipole arm 121A and the second dipole arm 121B may be symmetrical about the first axis Al or substantially symmetrical about the first axis Al, and/or the closed conductive segment of each of the third dipole arm 122A and the fourth dipole arm 122B may be symmetrical about the second axis A2 or substantially symmetrical about the second axis A2. In some embodiments, the conductive patch of each of the first dipole arm 121A and the second dipole arm 121B may be symmetrical about the first axis Al or substantially symmetrical about the first axis Al, and/or the conductive patch of each of the third dipole arm 122A and the fourth dipole arm 122B may be symmetrical about the second axis A2 or substantially symmetrical about the second axis A2. In some embodiments, each of the closed conductive segments 121a, 121b, 122a, and 122b on the dielectric substrate 123 may be rotationally symmetrical or substantially rotationally symmetrical about an intersection of the first axis Al and the second axis A2, and/or each of the conductive patches 121c, 121d, 122c, and 122d on the dielectric substrate 123 may be rotationally symmetrical or substantially rotationally symmetrical about the intersection of the first axis Al and the second axis A2. The symmetry can promote the closed conductive segment to show good operating performance when used as a dipole arm, and can also promote the frequency selective surface formed by the closed conductive segment and the conductive patch to have better periodicity and thus have better frequency selection performance.

FIG. 2A to FIG. 2E show several exemplary patterns that can be used for the frequency selective surface of the radiating element 100. As shown in FIGS. 2A to 2E, the first conductive structure formed by the closed conductive segments may include, for example, a grid array structure, and each closed conductive segment serves as a grid of a repeating unit in the grid array structure; the second conductive structure formed by the conductive patches may include, for example, a patch array structure, and each conductive patch serves as a patch of a repeating unit in the patch array structure. In some embodiments, the closed conductive segment of each of the first dipole arm to the fourth dipole arm, i.e., 121A, 121B, 122A, and 122B, may be in or substantially be in a square annular shape, and/or, the conductive patch of each of the first dipole arm to the fourth dipole arm, i.e., 121A, 121B, 122A, and 122B, may be or substantially be a polygon, (one or more) polygonal rings, or a combination of a polygon and (one or more) polygonal rings.

For example, as shown in FIG. 2C and FIG. 2D, the inner contour and outer contour of each of the closed conductive segments 121a, 121b, 122a, and 122b are square. In addition, as shown in FIGS. 2A, 2B, and 2E, the outer contour of each of the closed conductive segments 121a, 121b, 122a, and 122b is square, but the inner contour is pentagonal, that is, each of the closed conductive segments 121a, 121b, 122a, and 122b widens near the intersection of the first axis and the second axis to form a substantially triangular portion. This design is to facilitate feeding each of the closed conductive segments 121a, 121b, 122a, and 122b as a dipole arm.

For example, the shape and size of the conductive patch may be designed to match the shape and size of the closed conductive segment. Generally, the smaller the size of the conductive patch, the higher the frequency allowed by the obtained frequency selective surface to pass can be. Specifically, as shown in FIG. 2C, each of the conductive patches 121c, 121d, 122c, and 122d is a square patch, and as shown in FIG. 2D, each of the conductive patches 121c, 121d, 122c, and 122d is a square annular patch. Moreover, in order to match the design of the closed conductive segments 121a, 121b, 122a, and 122b to facilitate feeding, as shown in FIG. 2A, the conductive patches 121c, 121d, 122c, and 122d may also be changed to pentagonal patches correspondingly, and as shown in FIG. 2B, the conductive patches 121c, 121d, 122c, and 122d may also be changed to pentagonal annular patches correspondingly. In addition, as shown in FIG. 2E, the conductive patches 121c, 121d, 122c, and 122d may also include a combination of pentagonal patches and pentagonal annular patches.

The patterns used for the frequency selective surface of the radiating element 100 shown in FIGS. 2A to 2E are merely exemplary and not restrictive. The patterns of the closed conductive segments and the conductive patches may be specifically designed according to the operating frequency range of the radiator 120 and the frequency range in which the frequency selective surface needs to be configured to allow passage.

The present disclosure further provides a multi-band base station antenna, which may include the aforementioned radiating element based on the frequency selective surface, so that including radiating elements of different frequency bands in the multi-band base station antenna does not cause deterioration of antenna performance, especially radiation pattern performance.

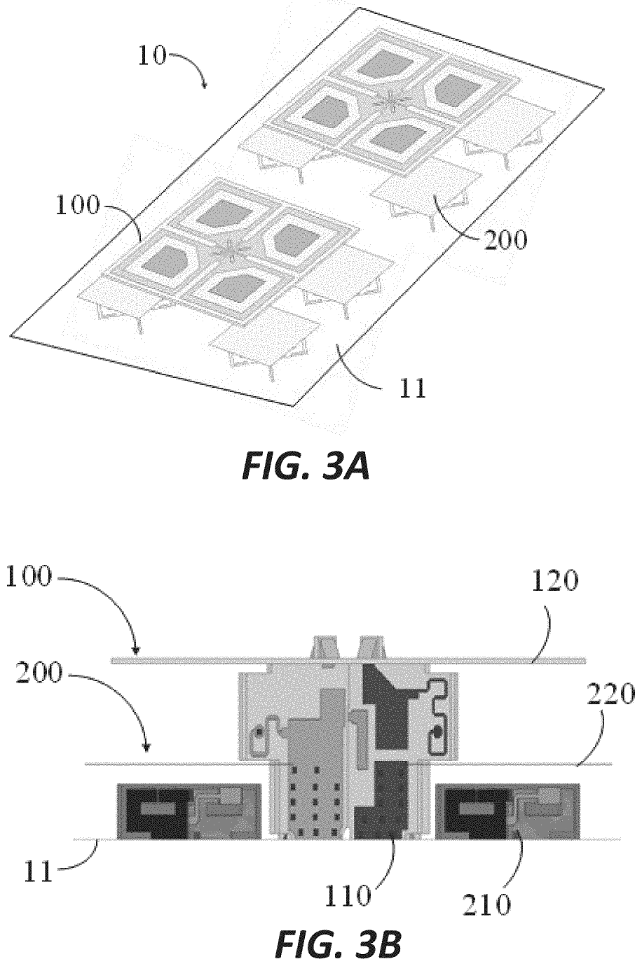

A multi-band base station antenna 10 according to some embodiments of the present disclosure will be described in detail with reference to FIGS. 3A and 3B. It should be noted that the actual base station antenna may also have other components, and in order to avoid obscuring the main points of the present disclosure, other components are not shown in the accompanying drawings and will not be discussed herein. It should also be noted that FIGS. 3A and 3B only schematically show the relative positional relationship of various components, and there is no particular limitation on the specific structure of each component.

The multi-band base station antenna 10 may include a reflector 11, a first radiating element 100 mounted on the reflector 11, and a second radiating element 200 mounted on the reflector 11. The first radiating element 100 may be configured to operate in a first operating frequency range. The second radiating element 200 may be configured to operate in a second operating frequency range which is higher than the first operating frequency range. The first radiating element 100 may be the radiating element 100 according to any of the aforementioned embodiments of the present disclosure, and the frequency selective surface of the first radiating element 100 may be configured to allow radiation in the second operating frequency range to pass.

In order to miniaturize the multi-band base station antenna 10, the first radiating element and the second radiating element may be arranged more compactly. In some embodiments, as can be seen more clearly from FIG. 3B, a radiator 120 of the first radiating element 100 is farther from the reflector 11 than a radiator 220 of the second radiating element 200. As can be seen more clearly in combination with FIG. 3A, when viewed from a direction perpendicular to the surface of the reflector 11, the radiator 120 of the first radiating element 100 covers at least a part of the radiator 220 of the second radiating element 200.

FIG. 4A and FIG. 4B show several exemplary compact layouts of the multi-band base station antenna 10. In some embodiments, the multi-band base station antenna 10 may include a plurality of first radiating elements 100 and a plurality of second radiating elements 200, and the plurality of first radiating elements 100 and the plurality of second radiating elements 200 may be arranged such that, when viewed from a direction perpendicular to the surface of the reflector 11, each first radiating element 100 at least partially overlaps with one or more second radiating elements 200. In some examples, when viewed from a direction perpendicular to the surface of the reflector 11, each second radiating element 200 of the one or more second radiating elements 200 with which each first radiating element 100 at least partially overlaps is located below a corresponding dipole arm of the first radiating element 100. For example, FIG. 4A and FIG. 4B show a multi-band base station antenna 10 including two columns of first radiating elements 100 and eight columns of second radiating elements 200, where each first radiating element 100 at least partially overlaps with four second radiating elements 200, and the four second radiating elements 200 are respectively located below a corresponding dipole arm of the first radiating element 100.

In a conventional multi-band base station antenna, when a radiator of a lower frequency band radiating element covers a radiator of a higher frequency band radiating element, it will cause serious distortion in the radiation pattern of the higher frequency band radiating element. This condition between a high-band (for example, 3.3 GHz to 4.2 GHz or a part thereof) radiating element and a mid-band (for example, 1.7 GHz to 2.7 GHz or a part thereof) is even worse than that between a mid-band (for example, 1.7 GHz to 2.7 GHz or a part thereof) radiating element and a low-band (for example, 617 MHz to 960 MHz or a part thereof) radiating element. Therefore, lower frequency band radiating elements are generally arranged outside an array of higher frequency band radiating elements, or the spacing between the radiating elements is increased to reduce the extent to which the higher frequency band radiating elements are covered by the lower frequency band radiating elements. However, this approach usually increases the size of the antenna, and this situation becomes more severe when the number of radiating elements included in the antenna increases and the operating frequency bands of the antenna increase. In contrast, in the multi-band base station antenna 10 according to the present disclosure, since the frequency selective surface of the first radiating element 100 can be configured to allow radiation in the second operating frequency range of the second radiating element 200 to pass, the radiation pattern of the second radiating element 200 will not be significantly affected even if the radiator 120 of the first radiating element 100 covers at least a part of the radiator 220 of the second radiating element 200.

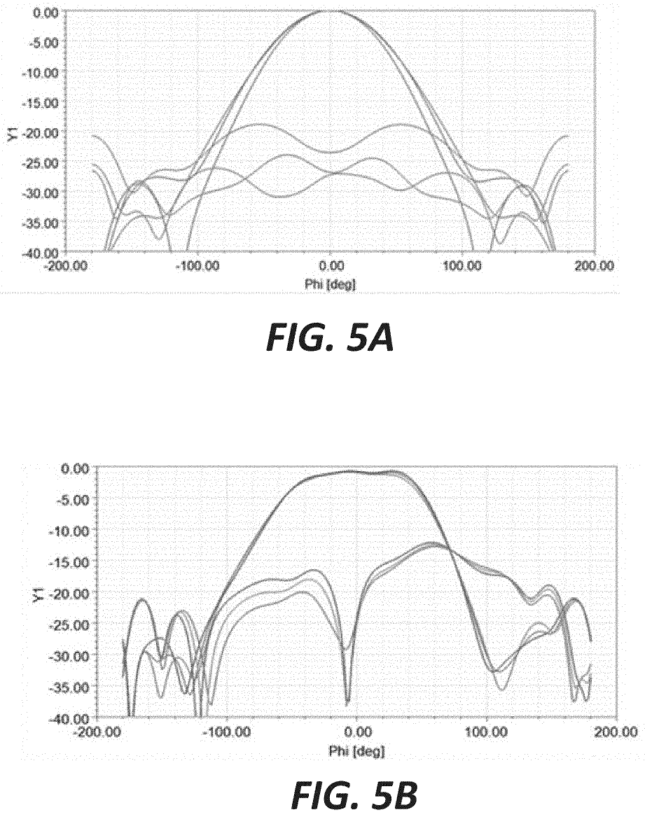

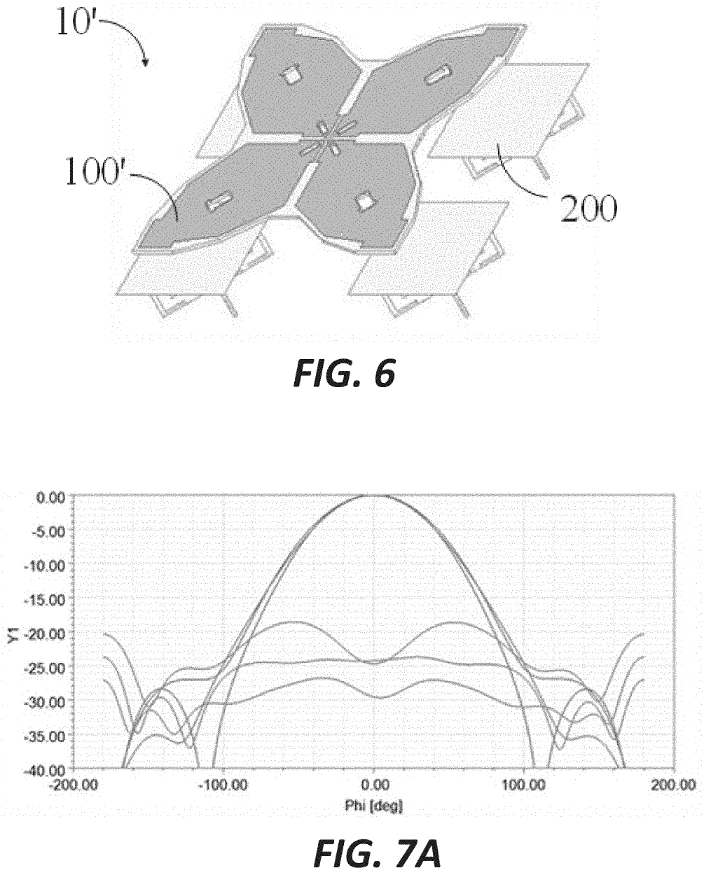

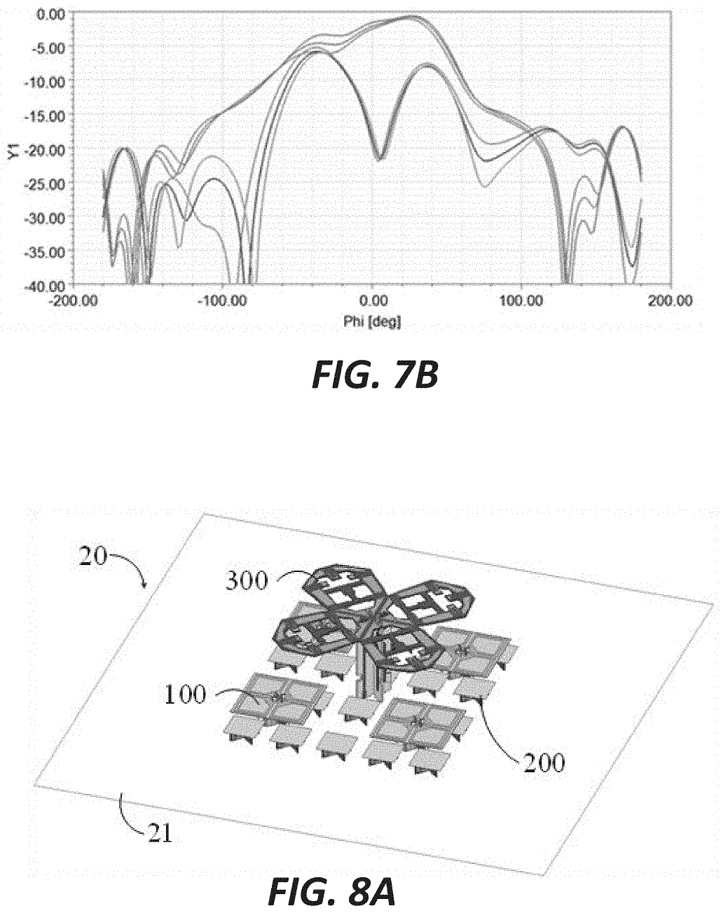

In order to show the excellent performance of the multi-band base station antenna 10 according to the present disclosure, FIG. 5A shows the radiation pattern of the first radiating element 100 (taking a mid-band radiating element as an example) of the multi-band base station antenna 10 according to the present disclosure at three operating frequency points, 1.7 GHz, 2.2 GHz, and 2.7 GHz, and FIG. 5B shows the radiation pattern of the second radiating element 200 (taking a high-band radiating element as an example) of the multi-band base station antenna 10 according to the present disclosure at three operating frequency points, 3.4 GHz, 3.5 GHz, and 3.6 GHz. In contrast, FIG. 6 shows a multi-band base station antenna 10′ that includes the same second radiating element 200 as the second radiating element 200 of the multi-band base station antenna 10 and which further includes a conventional cross dipole radiating element 100′ that does not allow radiation in the second operating frequency range of the second radiating element 200 to pass. FIG. 7A shows the radiation pattern of the first radiating element 100′ (taking a mid-band radiating element as an example) of multi-band base station antenna 10′ at three operating frequency points, 1.7 GHz, 2.2 GHz, and 2.7 GHz, and FIG. 7B shows the radiation pattern of the second radiating element 200 (taking a high-band radiating element as an example) of multi-band base station antenna 10′ at three operating frequency points, 3.4 GHz, 3.5 GHz, and 3.6 GHz. By comparing FIGS. 5A, 5B, 7A, and 7B, it can be seen that the radiation pattern of the second radiating element 200 of the conventional multi-band base station antenna 10′ is significantly distorted due to the effect of the first radiating element 100′, whereas the radiation pattern of the second radiating element 200 of the multi-band base station antenna 10 according to the present disclosure is slightly affected by the first radiating element 100 or hardly affected by the first radiating element 100.

Since the existence of the first radiating element 100 in the multi-band base station antenna 10 according to the present disclosure does not affect or has little effect on the operation of the second radiating element 200, the arrangement of the first radiating element 100 and the arrangement of the second radiating element 200 can be freely considered separately without worrying that an overlapping layout of the two will affect the operating performance of each other. Therefore, the multi-band base station antenna 10 according to the present disclosure can maintain high performance while achieving high integration and miniaturization.

In addition, in order to alleviate or eliminate the effect of the second radiating element 200 of a higher frequency band on the operation of the first radiating element 100 of a lower frequency band, in some embodiments, the second radiating element 200 may be a patch dipole radiating element. As shown in FIG. 3B, the second radiating element 200 may be a low-profile patch dipole radiating element (for example, its height (or the distance between the radiator and the reflector) may be only 10 mm). The low second radiating element 200 may be farther away from the radiator of the first radiating element 100, thereby alleviating the adverse effects caused by the overlap of the two. In addition, the second radiating element, which serves as a patch dipole radiating element, does not have a metal connection between its feed rod 210 and the radiator 220, but can be mounted by, for example, a plastic member or the like. This makes a gap between the feed rod 210 and the radiator 220 (for example, the gap may be 3 mm to 5 mm), and the gap greatly weakens the effect of the second radiating element 200 of a higher frequency band on the radiation pattern of the first radiating element 100 of a lower frequency band.

The multi-band base station antenna 10 according to the present disclosure exemplarily includes radiating elements of two frequency bands. However, the present disclosure is not limited thereto, and may include more kinds of radiating elements of different frequency bands. In some embodiments, the multi-band base station antenna according to the present disclosure may further include a third radiating element mounted on the reflector, and the third radiating element may be configured to operate in a third operating frequency range which is lower than the first operating frequency range. In some embodiments, the third radiating element may be configured to be cloaked to radiation in the first operating frequency range of the first radiating element and the second operating frequency range of the second radiating element.

For example, FIG. 8A exemplarily shows a multi-band base station antenna 20 according to the present disclosure. The multi-band base station antenna 20 may include a reflector 21, a first radiating element 100 mounted on the reflector 21, a second radiating element 200 mounted on the reflector 21, and a third radiating element 300 mounted on the reflector 21. The first radiating element 100 may be configured to operate in a first operating frequency range (for example, a frequency range of 1.7 GHz to 2.7 GHz or a portion thereof). The second radiating element 200 may be configured to operate in a second operating frequency range (for example, a frequency range of 3.3 GHz to 4.2 GHz or a portion thereof) which is higher than the first operating frequency range. The third radiating element 300 may be configured to operate in a third operating frequency range (for example, a frequency range of 617 MHz to 960 MHz or a portion thereof) which is lower than the first operating frequency range. The first radiating element 100 and the second radiating element 200 may be as described above. The frequency selective surface of the first radiating element 100 may be configured to allow radiation in the second operating frequency range of the second radiating element 200 to pass. The third radiating element 300 may be configured to be cloaked to radiation in the first operating frequency range of the first radiating element 100 and the second operating frequency range of the second radiating element 200. In other words, the third radiating element 300 may be configured to allow radiation in the first operating frequency range of the first radiating element 100 and the second operating frequency range of the second radiating element 200 to pass substantially unaffected.

In some embodiments, as shown in FIG. 8C, the third radiating element 300 may include a cross dipole radiator, and each dipole arm, 300A, 300B, 300C, and 300D, of the cross dipole radiator may include a corresponding conductive segment and a corresponding inductor capacitor circuit. The inductor capacitor circuit may define a filter, which may be configured to allow radiation in the first operating frequency range of the first radiating element 100 and the second operating frequency range of the second radiating element 200 to pass. As shown in FIG. 8C, each of the dipole arms 300A, 300B, 300C, and 300D includes a widened conductive segment 300a and a narrowed conductive segment 300b. The narrowed conductive segment 300b may be regarded as an inductor, and the gap between the narrowed conductive segment 300b and the widened conductive segment 300a may be regarded as a capacitor. Desired equivalent inductance and equivalent capacitance are achieved by designing the specific shape and size of the widened conductive segment 300a and the narrowed conductive segment 300b, so that the filter defined by the formed inductor capacitor circuit achieves a desired frequency range which allows passage of signals in the first operating frequency range and the second operating frequency range (i.e., the RF energy in the first and second operating frequency ranges will not tend to induce current on the dipole arms 300A, 300B, 300C, 300D).

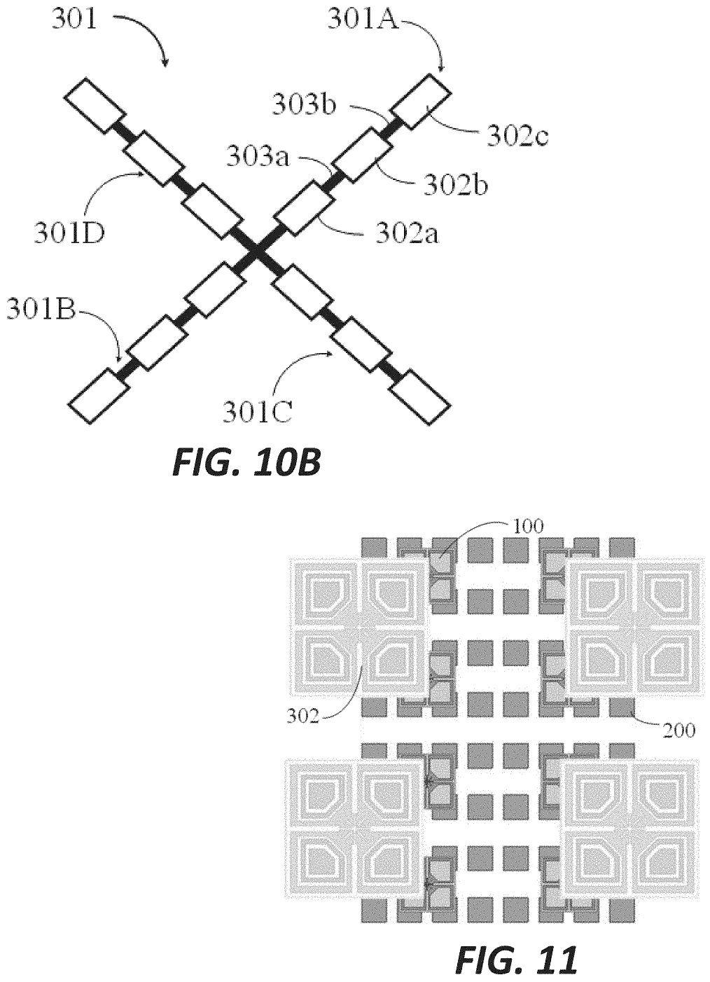

Of course, the example of the third radiating element is not limited to the third radiating element 300 shown in FIG. 8C. In some embodiments, as shown in FIG. 11, the third radiating element may be a radiating element 302 based on the frequency selective surface according to any embodiment of the present disclosure, and the frequency selective surface of the third radiating element 302 may be configured to allow radiation in the first operating frequency range of the first radiating element 100 and the second operating frequency range of the second radiating element 200 to pass. In some other embodiments, as shown in FIG. 10A and FIG. 10B, the third radiating element 301 includes a cross dipole radiator, and each dipole arm, 301A, 301B, 301C, and 301D, of the cross dipole radiator includes a plurality of dipole segments 302a, 302b, and 302c, and chokes 303a and 303b arranged between adjacent dipole segments of these dipole segments. The chokes are configured to minimize the effect of current induced in the dipole arm of the third radiating element 301 by radiation in the first operating frequency range of the first radiating element 100 and the second operating frequency range of the second radiating element 200. By using the choke characteristics, it is possible to improve the cloaking performance of the third radiating element 301 to radiation in the first operating frequency range of the first radiating element 100 and the second operating frequency range of the second radiating element 200, so that the third radiating element 301 does not affect or has little effect on the radiation patterns of the first radiating element 100 and the second radiating element 200.

In order to miniaturize the multi-band base station antenna 20, the first radiating element, the second radiating element, and the third radiating element may be arranged more compactly. In some embodiments, as can be seen more clearly from FIG. 8B, a radiator 320 of the third radiating element 300 is farther from the reflector 21 than the radiator 120 of the first radiating element 100, and the radiator 120 of the first radiating element 100 is farther from the reflector 21 than the radiator 220 of the second radiating element 200. Moreover, as can be seen more clearly in combination with FIG. 8A, when viewed from a direction perpendicular to the surface of the reflector 21, the radiator 320 of the third radiating element 300 covers at least a part of the radiator 120 of the first radiating element 100, and the radiator 120 of the first radiating element 100 covers at least a part of the radiator 220 of the second radiating element 200. Moreover, the radiator 320 of the third radiating element 300 may cover at least a part of the radiator 120 of the first radiating element 100 and at least a part of a radiator 220 of the second radiating element 200 that is covered by the first radiating element 100.

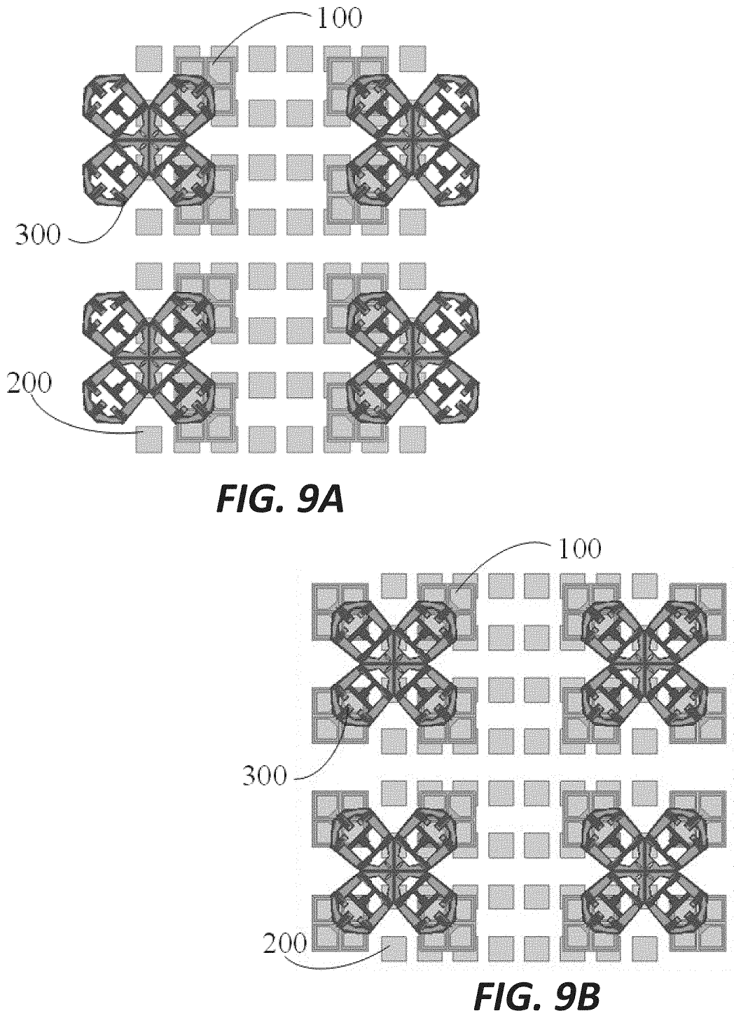

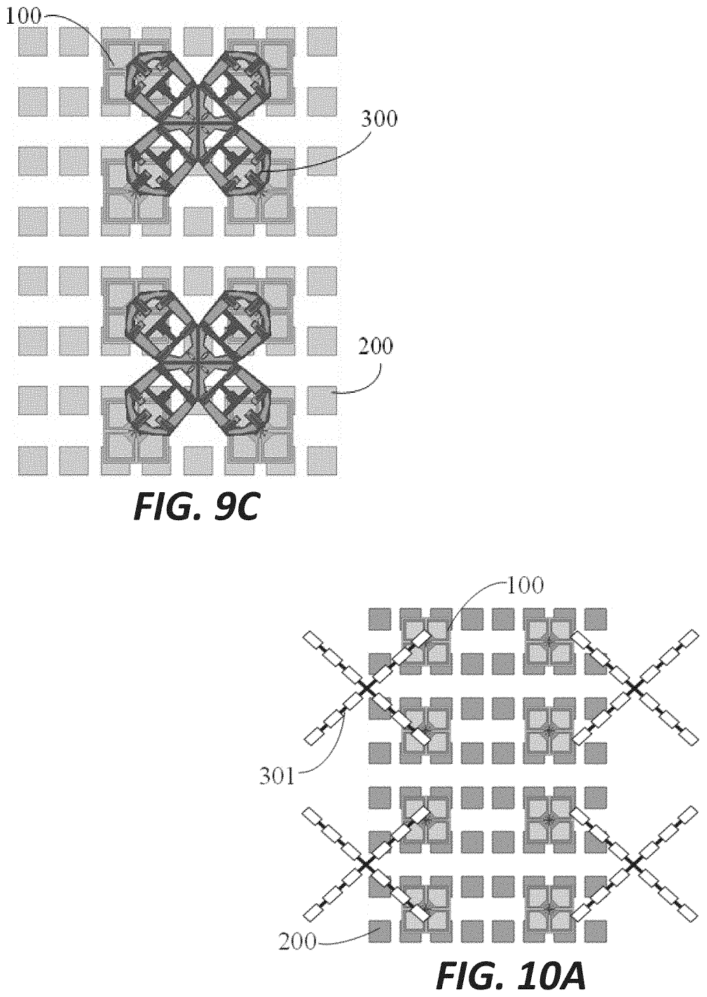

FIGS. 9A to 9C show several exemplary compact layouts of the multi-band base station antenna 20. In some embodiments, the multi-band base station antenna 20 may include a plurality of first radiating elements 100, a plurality of second radiating elements 200, and a plurality of third radiating elements 300, and they may be arranged such that, when viewed from a direction perpendicular to the surface of the reflector 21, each third radiating element 300 at least partially overlaps with one or more first radiating elements 100, and each first radiating element 100 at least partially overlaps with one or more second radiating elements 200. In some examples, when viewed from a direction perpendicular to the surface of the reflector 21, each first radiating element 100 of the one or more first radiating elements 100 with which each third radiating element 300 at least partially overlaps is located below a corresponding dipole arm of the third radiating element 300, and each second radiating element 200 of the one or more second radiating elements 200 with which each first radiating element 100 at least partially overlaps is located below a corresponding dipole arm of the first radiating element 100. For example, FIG. 9A shows a layout of two columns of third radiating elements 300, two columns of first radiating elements 100, and eight columns of second radiating elements 200, FIG. 9B shows a layout of two columns of third radiating elements 300, four columns of first radiating elements 100, and eight columns of second radiating elements 200, and FIG. 9C shows a layout of one column of third radiating elements 300, two columns of first radiating elements 100, and eight columns of second radiating elements 200.

As previously mentioned, in a conventional multi-band base station antenna, when a high-band (for example, 3.3 GHz to 4.2 GHz or a portion thereof) radiating element covers a mid-band (for example, 1.7 GHz to 2.7 GHz or a portion thereof) radiating element and a mid-band (for example, 1.7 GHz to 2.7 GHz or a part thereof) radiating element covers a low-band (for example, 617 MHz to 960 MHz or a portion thereof) radiating element, then the radiation pattern of the blocked radiating element of a higher frequency band will be severely distorted, leading to significant deterioration of the performance of the multi-band base station antenna. Therefore, lower frequency band radiating elements are generally arranged outside an array of higher frequency band radiating elements, or the spacing between the radiating elements is increased to avoid as much as possible the higher frequency band radiating elements being covered by the lower frequency band radiating elements to result in the distortion of the radiation pattern. However, this usually increases the size of the antenna, and this situation becomes more severe when the number of radiating elements included in the antenna increases and the operating frequency bands of the antenna increase. In contrast, in the multi-band base station antenna 20 according to the present disclosure, since the frequency selective surface of the first radiating element 100 can be configured to allow radiation in the second operating frequency range of the second radiating element 200 to pass, and the frequency selective surface of the third radiating element 300 can be configured to allow radiation in the first operating frequency range of the first radiating element 100 and the second operating frequency range of the second radiating element 200 to pass, the radiation patterns of the first radiating element 100 and the second radiating element 200 will not be significantly affected even if the radiator 120 of the first radiating element 100 covers at least a part of the radiator 220 of the second radiating element 200 and the radiator 320 of the third radiating element 300 covers at least a part of the radiator 120 of the second radiating element 100.

In the multi-band base station antenna 20 according to the present disclosure, the existence of the first radiating element 100 does not affect or has little effect on the operation of the second radiating element 200, and the existence of the third radiating element 300 does not affect or has little effect on the operation of the first radiating element 100 and the second radiating element 200. Therefore, the arrangement of the first radiating element 100, the arrangement of the second radiating element 200, and the arrangement of the third radiating element 300 can be freely considered separately without worrying that an overlapping layout of them will affect the operating performance of one other. Therefore, the multi-band base station antenna 20 according to the present disclosure can maintain high performance while achieving high integration and miniaturization.

The terms “left”, “right”, “front”, “rear”, “top”, “bottom”, “upper”, “lower”, “high”, “low” in the Specification and claims, if present, are used for descriptive purposes and not necessarily used to describe constant relative positions. It should be understood that the terms used in this way are interchangeable under appropriate circumstances, so that the embodiments of the present disclosure described herein, for example, can operate on other orientations that differ from those orientations shown herein or otherwise described. For example, when the device in the drawing is turned upside down, features that were originally described as “above” other features can now be described as “below” other features. The device may also be oriented by other means (rotated by 90 degrees or at other locations), and at this time, a relative spatial relation will be explained accordingly.

In the descriptions and claims, when an element is referred to as being “above” another element, “attached” to another element, “connected” to another element, “coupled” to another element, or “contacting” another element, the element may be directly above another element, directly attached to another element, directly connected to another element, directly coupled to another element, or directly contacting another element, or there may be one or multiple intermediate elements. In contrast, if an element is described “directly” “above” another element, “directly attached” to another element, “directly connected” to another element, “directly coupled” to another element or “directly contacting” another element, there will be no intermediate elements. In the descriptions and claims, a feature that is arranged “adjacent” to another feature, may denote that a feature has a part that overlaps an adjacent feature or a part located above or below the adjacent feature.

As used herein, the word “exemplary” means “serving as an example, instance, or illustration” rather than as a “model” to be copied exactly. Any realization method described exemplarily herein is not necessarily interpreted as being preferable or advantageous over other realization methods. Moreover, the present disclosure is not limited by any expressed or implied theory given in the technical field, background art, summary of the invention, or specific implementation methods.

As used herein, the word “substantially” means comprising any minor changes caused by design or manufacturing defects, device or component tolerances, environmental influences, and/or other factors. The word “substantially” also allows the gap from the perfect or ideal situation due to parasitic effects, noise, and other practical considerations that may be present in the actual realization.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order. It should also be understood that when the term “include/comprise” is used in this text, it indicates the presence of the specified feature, entirety, step, operation, unit and/or component, but does not exclude the presence or addition of one or more other features, entireties, steps, operations, units and/or components and/or combinations thereof. In the present disclosure, the term “provide” is used in a broad sense to cover all ways of obtaining an object, so “providing an object” includes but is not limited to “purchase”, “preparation/manufacturing”, “arrangement/setting”, “installation/assembly”, and/or “order” of the object, etc.

As used herein, the term “and/or” includes any and all combinations of one or more of the associated listed items. The terms used herein are only for the purpose of describing specific embodiments, and are not intended to limit the present disclosure. As used herein, the singular forms “a”, “an” and “the” are also intended to include the plural forms, unless the context clearly dictates otherwise.

Those skilled in the art should realize that the boundaries between the above operations are merely illustrative. A plurality of operations can be combined into a single operation, which may be distributed in the additional operation, and the operations can be executed at least partially overlapping in time. Also, alternative embodiments may include multiple instances of specific operations, and the order of operations may be changed in other various embodiments. However, other modifications, changes and substitutions are also possible. Aspects and elements of all embodiments disclosed above may be combined in any manner and/or in conjunction with aspects or elements of other embodiments to provide multiple additional embodiments. Therefore, the Specification and attached drawings hereof should be regarded as illustrative rather than limitative.

Although some specific embodiments of the present disclosure have been described in detail through examples, those skilled in the art should understand that the above examples are only for illustration rather than for limiting the scope of the present disclosure. The embodiments disclosed herein can be combined arbitrarily without departing from the spirit and scope of the present disclosure. Those skilled in the art should also understand that various modifications can be made to the embodiments without departing from the scope and spirit of the present disclosure. The scope of the present disclosure is defined by the attached claims.

1. A radiating element, including:
a feed stalk; and
a radiator mounted on the feed stalk, the radiator including:
a dielectric substrate;
a first dipole arranged along a first axis and including a first dipole arm and a second dipole arm; and
a second dipole arranged along a second axis perpendicular to the first axis and including a third dipole arm and a fourth dipole arm,
wherein each of the first dipole arm to the fourth dipole arm includes a closed conductive segment provided on the dielectric substrate;
wherein conductive patches are respectively provided on the dielectric substrate within boundaries defined by the closed conductive segment of each of the first dipole arm to the fourth dipole arm, and
wherein the dielectric substrate with the closed conductive segments and conductive patches constitutes a frequency selective surface which is configured to allow radiation in a frequency range higher than the operating frequency range of the radiating element to pass.

2. The radiating element according to claim 1,
wherein the closed conductive segment of each of the first dipole arm and the second dipole arm is symmetrical about the first axis, and/or
wherein the closed conductive segment of each of the third dipole arm and the fourth dipole arm is symmetrical about the second axis.

3. The radiating element according to claim 1,
wherein the conductive patch within each of the first dipole arm and the second dipole arm is symmetrical about the first axis, and/or
wherein the conductive patch within each of the third dipole arm and the fourth dipole arm is symmetrical about the second axis.

4. The radiating element according to claim 1,
wherein each closed conductive segment on the dielectric substrate is rotationally symmetrical about an intersection of the first axis and the second axis, and/or
wherein each conductive patch on the dielectric substrate is rotationally symmetrical about the intersection of the first axis and the second axis.

5. The radiating element according to claim 1,
wherein the closed conductive segment of each of the first dipole arm to the fourth dipole arm is in a square annular shape, and/or
wherein the conductive patch within each of the first dipole arm to the fourth dipole arm is a polygon, a polygonal ring, or a combination of a polygon and a polygonal ring. 6-14. (Cancelled)

15. A multi-band base station antenna, including:
a reflector;
a first radiating element mounted on the reflector, the first radiating element being configured to operate in a first operating frequency range; and
a second radiating element mounted on the reflector, the second radiating element being configured to operate in a second operating frequency range which is higher than the first operating frequency range,
wherein the first radiating element is the radiating element according to claim 1, and the frequency selective surface of the first radiating element is configured to allow radiation in the second operating frequency range to pass.

16. The multi-band base station antenna according to claim 15, wherein a radiator of the first radiating element is farther from the reflector than the radiator of the second radiating element, and when viewed from a direction perpendicular to the surface of the reflector, the radiator of the first radiating element covers at least a part of the radiator of the second radiating element.

17. The multi-band base station antenna according to claim 15, wherein the multi-band base station antenna includes a plurality of first radiating elements and a plurality of second radiating elements, and the plurality of first radiating elements and the plurality of second radiating elements are arranged such that, when viewed from a direction perpendicular to the surface of the reflector, each first radiating element at least partially overlaps with one or more second radiating elements.

18. The multi-band base station antenna according to claim 17, wherein when viewed from a direction perpendicular to the surface of the reflector, each of the one or more second radiating elements with which each first radiating element at least partially overlaps is located below a corresponding dipole arm of that first radiating element.

19. (canceled)

20. The multi-band base station antenna according to claim 15, wherein the multi-band base station antenna further includes a third radiating element mounted on the reflector, and the third radiating element is configured to operate in a third operating frequency range which is lower than the first operating frequency range.

21. The multi-band base station antenna according to claim 20, wherein the third radiating element is configured to be cloaked to radiation in the first operating frequency range and the second operating frequency range.

22. The multi-band base station antenna according to claim 21, wherein the third radiating element is the radiating element according to claim 1, and the frequency selective surface of the third radiating element is configured to allow radiation in the first operating frequency range and the second operating frequency range to pass. 23-28. (Cancelled)

29. A radiating element, including:
a feed stalk; and
a radiator mounted on the feed stalk, the radiator including a plurality of dipole arms,
wherein the dipole arms are part of a frequency selective surface that is configured to pass radiation in a pre-selected frequency band.

30. The radiating element according to claim 29, wherein the frequency selective surface comprises a parallel inductor-capacitor resonance circuit.

31. The radiating element according to claim 29, wherein the radiator further includes a plurality of conductive patches.

32. The radiating element according to claim 31, wherein each dipole arm defines an open interior, and wherein each conductive patch is positioned within an open interior of a respective one of the dipole arms.

33. The radiating element according to claim 32, wherein the dipole arms and the conductive patches are formed on a dielectric substrate.

34. The radiating element according to claim 33, wherein at least a portion of the conductive patch is on a different surface of the dielectric substrate than at least a portion of one of the dipole arms.

35. A multi-band base station antenna, including:
a reflector;
a first radiating element mounted on the reflector, the first radiating element being configured to operate in a first operating frequency range; and
a second radiating element mounted on the reflector, the second radiating element being configured to operate in a second operating frequency range which is higher than the first operating frequency range,
wherein the first radiating element is the radiating element according to claim 29 and the frequency selective surface of the first radiating element is configured to allow radiation in the second operating frequency range to pass.

36. The multi-band base station antenna according to claim 35, wherein a radiator of the first radiating element is farther from the reflector than the radiator of the second radiating element, and when viewed from a direction perpendicular to the surface of the reflector, the radiator of the first radiating element covers at least a part of the radiator of the second radiating element.
